(19) United States
(12) Patent Application Publication
(10) Pub. No.: US 2006/0269865 A1
(43) Pub. Date: Nov. 30, 2006

(54) Production process of polymerized toner

(75) Inventor: Fuminari Oyama, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: ZEON CORPORATION, Tokyo (JP)

(21) Appl. No.: 11/440,046

(22) Filed: May 25, 2006

(30) Foreign Application Priority Data
May 27, 2005 (JP) 2005-156405

(51) Int. Cl. G03G 9/08

(52) U.S. Cl. 430/137.11; 430/137.15

(57) ABSTRACT

A process for producing a polymerized toner, which comprises a step of forming colored polymer particles, including a step of polymerizing a polymerizable monomer composition containing a polymerizable monomer and a colorant in an aqueous medium containing a dispersion stabilizer, a step of washing the colored polymer particles formed, and a step of collecting the colored polymer particles, wherein the washing step comprises an acid-washing or alkali-washing step, a step of conducting water washing until the electric conductivity of a filtrate is lowered to at most 1,000 μS/cm, and a centrifugal separation step by a decanter type centrifugal separator, and the number of secondarily produced fine particles adhered to the individual colored polymer particles is at most forty on the average.

### BACKGROUND OF THE INVENTION

1. Field of the Invention

The present invention relates to a production process of a polymerized toner used in development for copying machines, facsimiles, printers and the like by an electrophotographic system.

In the present invention, the polymerized toner means colored polymer particles obtained by a polymerization process and also means those obtained by adding an external additive to the colored polymer particles. The colored polymer particles include core-shell type colored polymer particles having a shell layer on the surfaces thereof.

2. Description of the Related Art

In image forming apparatus using an electrophotographic system, such as copying machines, facsimiles and printers, a pulverized toner has been commonly used as a developer for developing an electrostatic latent image. The pulverized toner is a toner obtained by kneading a binder resin obtained in advance by polymerization with a colorant and additive components such as a charge control agent and a parting agent, and then pulverizing and classifying the kneaded product. The pulverized toner is in an undefined form (non-spherical form), and its particle diameter distribution is also broad.

In recent years, image forming apparatus using the electrophotographic system have greatly needed to form color images. Color printing requires high resolution, and there is a demand for development of high-quality color toners capable of meeting such a requirement. There is also a demand for reduction in printing cost, and so a toner is required to have high durability.

A spherical toner having a small particle diameter is suitable for improvement in the resolution of the printed image because such a toner can reconcile good transferability with dot reproducibility. As such a spherical toner having a small particle diameter, are used colored polymer particles (polymerized toner) obtained by polymerizing a polymerizable monomer composition containing a colorant and a polymerizable monomer. According to the polymerization process, the spherical toner having a small particle diameter can be easily produced. In addition, according to the polymerization process, a polymerized toner having a narrow particle diameter distribution can be provided. Accordingly, the polymerized toner can meet the requirement of high resolution with better results than the pulverized toner.

In the production process of a toner according to the polymerization process, a suspension polymerization process is widely used. In the suspension polymerization process, a polymerizable monomer composition is prepared by mixing a polymerizable monomer, a colorant and optional other additive components. The polymerizable monomer composition is dispersed in an aqueous medium containing a dispersion stabilizer. The aqueous medium with the polymerizable monomer composition dispersed therein is stirred with high shearing force by means of a high-speed agitator or the like to form minute droplets of the polymerizable monomer composition in the aqueous medium. The polymerizable monomer composition dispersed in the form of droplets in the aqueous medium is polymerized in the presence of a polymerization initiator to form colored polymer particles. The aqueous medium containing the colored polymer particles formed is filtered through a filter medium, and the resultant filter cake is subjected to respective steps of washing, dehydration and drying to collect the colored polymer particles.

Although the colored polymer particles obtained in such a manner may also be used as a polymerized toner (developer) by themselves, an external additive such as inorganic fine particles is generally added thereto to improve their flowability and charging ability. The colored polymer particles or the colored polymer particles with the external additive added thereto may be used as a one-component developer. When the colored polymer particles or the colored polymer particles with the external additive added thereto are mixed with a carrier, a two-component developer can be provided.

The spherical colored polymer particles (polymerized toner) having a small particle diameter generally have a volume average particle diameter of about 3 to 15 μm. When the polymerizable monomer composition is polymerized in the aqueous medium to form colored polymer particles, however, fine particles such as fine polymer particles of sub-micron order (particle diameter smaller than 1 μm) are secondarily produced in addition of the intended colored polymer particles. In the present invention, the fine particles secondarily produced are referred to as “secondarily produced polymer particles”.

When a great amount of the secondarily produced fine polymer particles are formed, a filter medium is clogged with a part of the secondarily produced fine polymer particles when the colored polymer particles formed are separated by filtration through the filter medium from the aqueous medium, thereby lowering filtering speed or causing a failure in dehydration.

The secondarily produced fine polymer particles adhere to the surfaces of the colored polymer particles collected. When the colored polymer particles, to which a great amount of the secondarily produced fine polymer particles adhered, are used as a polymerized toner, the secondarily produced fine polymer particles liberated from the polymer toner upon formation of an image adhere to each member of an image forming apparatus. When such a polymerized toner is used to conduct printing on a great number of sheets, the secondarily produced fine polymer particles adhered to each member gradually accumulate to form a film. This is called a filming phenomenon.

When the secondarily produced fine polymer particles adhere to a developing blade or a sealing member between a developing roll and a developer-storing portion to cause a filming phenomenon, it is impossible to form an even toner layer on the developing roll, so that vertical stripes are easy to occur in an image. When the secondarily produced fine polymer particles adhere to the developing roll or a photosensitive member to cause a filming phenomenon, fogging occurs on a recording medium such as paper.

When the surface of the photosensitive member or the like is covered with the secondarily produced fine polymer particles, the polymerized toner covers thereon, whereby a filming phenomenon by the polymerized toner is easy to occur. When the secondarily produced fine polymer particles liberated from the polymerized toner accumulate in the polymerized toner remaining in the developer-storing portion as the number of printed sheets increases, the durability of the polymerized toner is more deteriorated. When the durability of the polymerized toner is poor, the filming phenomenon occurs, or the quality of an image formed is markedly lowered even when the number of printed sheets is small.

Japanese Patent Application Laid-Open No. 5-100484 (hereinafter referred to as “Article 1”) has proposed a method of containing a radical polymerization inhibitor, which is soluble in a polymerizable monomer and in an alkaline aqueous medium, in a polymerizable monomer composition in a production process of a polymerized toner by the suspension polymerization process. Article 1 states that this method can inhibit new particles (i.e., secondarily produced fine polymer particles) having a fine particle diameter from being secondarily produced. According to the method of using the radical polymerization inhibitor described in Article 1, however, the formation of the secondarily produced fine polymer particles may not be sufficiently prevented in some cases according to the kind of the colorant used.

Japanese Patent Application Laid-Open No. 2003-131426 (hereinafter referred to as “Article 2”) has proposed a method of conducting the separation of colored particles from an aqueous medium by filtration by means of a decanter type centrifugal separator, which has an outside rotary cylinder and a screw conveyor relatively rotatably provided within the outside rotary cylinder, for removing fine particles remaining without being aggregated by fusion bonding in a process for producing colored particles (aggregated toner) by fusion-bonding at least fine resin particles and fine colorant particles in the aqueous medium. Although the method of conduct the separation by filtration by means of the decanter type centrifugal separator described in Article 2 is effective for the aggregated toner, it has however been proved that when this method is applied to an aqueous dispersion containing colored polymer particles formed by the polymerization process, secondarily produced fine polymer particles adhered to the surfaces of the colored polymer particles cannot be sufficiently removed.

Japanese Patent Application Laid-Open No. 2004-133326 (hereinafter referred to as “Article 3”) has proposed a process comprising polymerizing a polymerizable monomer composition containing a colorant and a polymerizable monomer in an aqueous medium to form colored polymer particles and then separating the colored polymer particles from the aqueous medium by means of a screw type vertical centrifugal separator. According to the process making use of the screw type vertical centrifugal separator described in Article 3, colored polymer particles having a low water content, from which fine particles have been removed, can be provided from an aqueous dispersion containing the colored polymer particles by efficient solid-liquid separation. However, it is difficult even by the process described in Article 3 to sufficiently remove the secondarily produced fine polymer particles adhered to the surfaces of the colored polymer particles.

### BRIEF SUMMARY OF THE INVENTION

It is an object of the present invention to provide a process for stably and efficiently producing a polymerized toner which is extremely little in the number of secondarily produced fine particles such as fine polymer particles of sub-micron order produced upon polymerization of a polymerizable monomer composition in an aqueous medium and adhered to colored polymer particles formed, hard to cause a filming phenomenon even when durable printing (continuous printing) is conducted, and markedly excellent in durability.

The present inventors have carried out an extensive investigation with a view toward achieving the above object. As a result, it has been found that a polymerizable monomer composition is polymerized in an aqueous medium containing a dispersion stabilizer to form colored polymer particles, and an acid-washing or alkali-washing step, a water-washing step and a centrifugal separation step making use of a decanter type centrifugal separator are then combined with one another in a step of washing the colored polymer particles, thereby providing colored polymer particles, in which the number of secondarily produced fine particles of sub-micron order, which adhere to a colored polymer particle, is at most forty on the average. The present invention has been led to completion on the basis of this finding.

According to the present invention, there is thus provided a process for producing a polymerized toner, which comprises:

Step 1 of forming colored polymer particles, including the step of polymerizing a polymerizable monomer composition containing a polymerizable monomer and a colorant in an aqueous medium containing a dispersion stabilizer;

Step 2 of washing the colored polymer particles formed; and

Step 3 of collecting the colored polymer particles, wherein

the washing step 2 comprises:

i) an acid-washing or alkali-washing step 2a of adding an acid or alkali to an aqueous dispersion containing the colored polymer particles formed in the forming step 1 to dissolve the dispersion stabilizer;

ii) a water-washing step 2b of separating the colored polymer particles by filtration from the aqueous dispersion after the acid-washing or alkali-washing step 2a, then washing the colored polymer particles with water until the electric conductivity of a filtrate is lowered to at most 1,000 μS/cm, and filtering the washing water; and

iii) a centrifugal separation step 2c of adding water to the colored polymer particles in a wetted state obtained in the water-washing step 2b to prepare an aqueous dispersion containing the colored polymer particles again, and then feeding the aqueous dispersion to a decanter type centrifugal separator, which has an outside rotary cylinder and a screw conveyor relatively rotatably provided within the outside rotary cylinder, thereby conducting the centrifugal separation of the colored polymer particles, and wherein

the number of secondarily produced fine particles of sub-micron order, which adhere to the individual colored polymer particles obtained by the washing step 2, is at most forty on the average.

In the water-washing step 2b according to the present invention, it may be preferable to adopt a process comprising separating the colored polymer particles by filtration from the aqueous dispersion after the acid-washing or alkali-washing step 2a using at least one washing device selected from the group consisting of a belt filter, a rotary filter and a filter press, then washing the colored polymer particles with water until the electric conductivity of a filtrate is lowered to at most 1,000 μS/cm, and filtering the washing water.

In the collecting step 3 according to the present invention, the colored polymer particles in a wetted state, which have been subjected to centrifugal separation in the centrifugal separation step 2c, are dehydrated and dried. In this dehydration step, it may be preferable to adopt a process comprising conducting the dehydration by means of a siphon peeler type centrifuge.

### BRIEF DESCRIPTION OF THE DRAWINGS

FIG. 1 is a cross-sectional view illustrating the construction of a decanter type centrifugal separator, which has an outside rotary cylinder and a screw conveyor relatively rotatably provided within the outside rotary cylinder and is used in the present invention.

FIG. 2 illustrates flow diagrams from an acid-washing step to a dehydration step in Examples 1 and 2, and Comparative Examples 1 to 3. In FIG. 2, conditions in each step are also illustrated.

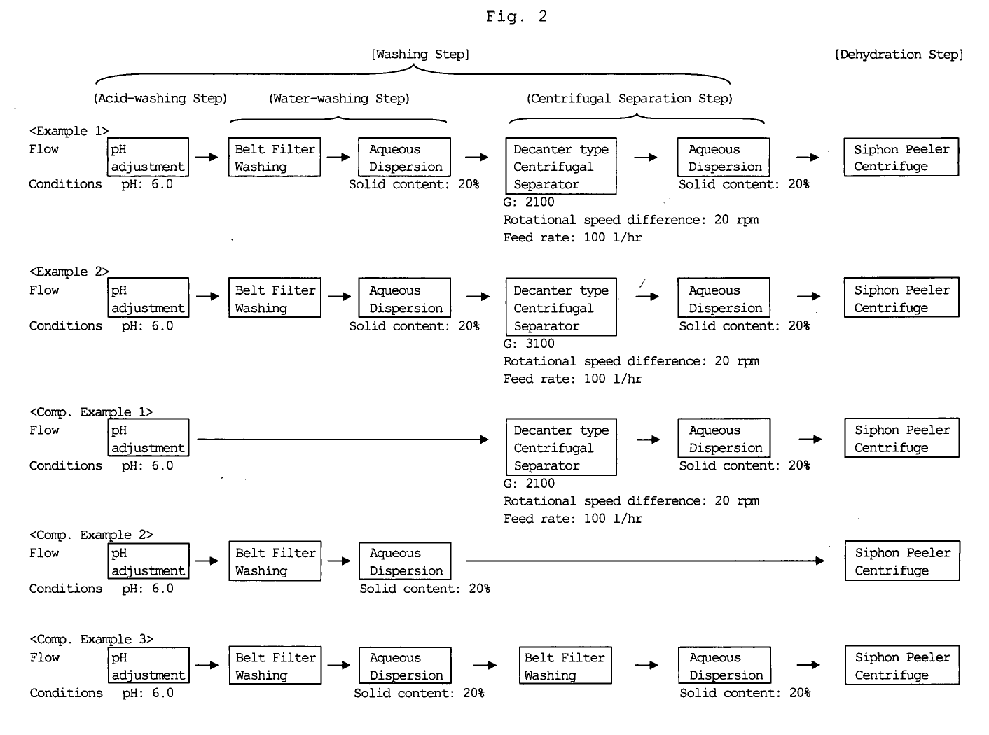

### DETAILED DESCRIPTION OF THE INVENTION

1. Outline of Production Process of Polymerized Toner:

The polymerized toner according to the present invention can be produced through the following respective steps. A polymerizable monomer, a colorant and optional other additive components are first mixed to prepare a polymerizable monomer composition. The other additive components include a charge control agent, a molecular weight modifier, a parting agent and the like.

This polymerizable monomer composition is then poured into an aqueous medium containing a dispersion stabilizer and stirred with high shearing force by means of a high-speed agitator or the like to form minute droplets of the polymerizable monomer composition in the aqueous medium. As the dispersion stabilizer, is used an inorganic compound soluble in an acid or an inorganic compound soluble in an alkali.

The polymerizable monomer composition dispersed in the form of droplets in the aqueous dispersion is polymerized in the presence of a polymerization initiator to form colored polymer particles. The polymerization initiator is contained in the polymerizable monomer composition in advance or in the aqueous medium in the course of the step of forming the droplets of the polymerizable monomer composition to be caused to migrate into the droplets of the polymerizable monomer composition. The aqueous dispersion containing the colored polymer particles formed is filtered through a filter medium, and the resultant filter cake is then subjected to respective steps of washing, dehydration and drying to collect the colored polymer particles.

In the production process according to the present invention, the washing step is performed by 3 steps of an acid-washing or alkali-washing step, a water-washing step and a centrifugal separation step. After the washing step, the colored polymer particles in a wetted state are dehydrated and then dried. The colored polymer particles obtained in such a manner are narrow in particle diameter distribution and may be used without conducting classification. However, classification may also be performed as needed.

Although the colored polymer particles may also be used as a polymerized toner (developer) as they are, an external additive is generally added thereto to improve their flowability and charging ability. The colored polymer particles or the colored polymer particles with the external additive added thereto may be used as a one-component developer. However, they may be mixed with a carrier, thereby providing a two-component developer.

2. Polymerizable Monomer Composition:

The polymerizable monomer composition used in the present invention is prepared by mixing a polymerizable monomer, a colorant and optional other additive components. The colorant and other additive components are preferably dissolved in the polymerizable monomer or dispersed therein as evenly and finely as possible. In order to evenly and finely mix the respective components, it is preferable to conduct the dispersion by means of a media type dispersing machine.

The polymerizable monomer used in the present invention means a polymerizable compound and is generally a compound having a radical polymerizable carbon-carbon double bond. A monovinyl monomer is preferably used as a main component of the polymerizable monomer. Examples of the monovinyl monomer include styrene; styrene derivatives such as vinyltoluene and α-methylstyrene; acrylic acid and methacrylic acid; acrylates such as methyl acrylate, ethyl acrylate, propyl acrylate, butyl acrylate, 2-ethylhexyl acrylate and dimethylaminoethyl acrylate; methacrylates such as methyl methacrylate, ethyl methacrylate, propyl methacrylate, butyl methacrylate, 2-ethylhexyl methacrylate and dimethylaminoethyl methacrylate; acrylic acid derivatives and methacrylic acid derivatives such as acrylonitrile, methacrylonitrile, acrylamide and methacrylamide; olefins such as ethylene, propylene and butylene; vinyl halides and vinylidene halides such as vinyl chloride, vinylidene chloride and vinyl fluoride; vinyl esters such as vinyl acetate and vinyl propionate; vinyl ethers such as vinyl methyl ether and vinyl ethyl ether; vinyl ketones such as vinyl methyl ketone and methyl isopropenyl ketone; and nitrogen-containing vinyl compounds such as 2-vinylpyridine, 4-vinylpyridine and N-vinyl-pyrrolidone.

These monovinyl monomers may be used either singly or in any combination thereof. Among these monovinyl monomers, styrene, the styrene derivatives and the acrylic acid or methacrylic acid derivatives may preferably be used.

The monovinyl monomer(s) may desirably be selected in such a manner that the glass transition temperature (Tg) of a polymer obtained by polymerizing it is generally 80° C. or lower, preferably 40 to 80° C., more preferably 50 to 70° C. The monovinyl monomers are used either singly or in combination of 2 or more monomers thereof, whereby the Tg of the polymer formed can be controlled within a desired range.

An optional crosslinkable polymerizable monomer (hereinafter may be referred to as “crosslinking agent”) is preferably used together with the monovinyl monomer for the purpose of improving the hot offset resistance of the resulting toner. The crosslinkable polymerizable monomer means a polymerizable monomer having at least two polymerizable functional groups. As examples of the crosslinkable polymerizable monomer, may be mentioned aromatic divinyl compounds such as divinylbenzene, divinylnaphthalene and derivatives thereof; di(meth)acrylate compounds such as ethylene glycol dimethacrylate and diethylene glycol dimethacrylate; other divinyl compounds such as N,N-divinylaniline and divinyl ether; and compounds having three or more vinyl groups. These crosslinkable polymerizable monomers may be used either singly or in any combination thereof.

In the present invention, the crosslinkable polymerizable monomer is used in a proportion of generally 0.1 to 5 parts by weight, preferably 0.3 to 2 parts by weight per 100 parts by weight of the monovinyl monomer.

It is preferable to use a macromonomer as a part of the polymerizable monomer because a balance between the storage stability and the low-temperature fixing ability of the resulting polymerized toner can be improved. The macromonomer is a reactive oligomer or polymer having a polymerizable carbon-carbon unsaturated double bond at its molecular chain terminal and a number average molecular weight of generally 1,000 to 30,000.

The macromonomer is preferably that giving a polymer having a Tg higher than that of a polymer obtained by polymerizing the monovinyl monomer. The amount of the macromonomer used is generally 0.01 to 10 parts by weight, preferably 0.03 to 5 parts by weight, more preferably 0.05 to 1 part by weight per 100 parts by weight of the monovinyl monomer.

In the present invention, a colorant is contained in the polymerizable monomer, thereby forming colored polymer particles. In general, 4 kinds of toners of a black toner, a cyan toner, a yellow toner and a magenta toner are used in full-color printing. When these toners are prepared, a black colorant, a cyan colorant, a yellow colorant and a magenta colorant may thus be respectively used to prepare polymerized toners of the respective colors.

As black colorants, may be used pigments, such as carbon black, titanium black and magnetic powders such as zinc iron oxide and nickel iron oxide.

As cyan colorants, may be used, for example, copper phthalocyanine compounds and derivatives thereof, and anthraquinone compounds. Specific examples thereof include C.I. Pigment Blue 2, 3, 6, 15, 15:1, 15:2, 15:3, 15:4, 16, 17:1 and 60. Copper phthalocyanine compounds such as C.I. Pigment Blue 15, 15:1, 15:2, 15:3, 15:4 and 17:1 are preferred in that they are stable to polymerization and have high tinting strength, with C.I. Pigment Blue 15:3 being more preferred.

As yellow colorants, may be used, for example, compounds, such as azo pigments such as mono-azo pigments and dis-azo pigments, and fused polycyclic pigments. Specific examples thereof include C.I. Pigment Yellow 3, 12, 13, 14, 15, 17, 62, 65, 73, 74, 83, 93, 97, 120, 138, 155, 180, 181, 185 and 186. Mono-azo pigments such as C.I. Pigment Yellow 3, 15, 65, 73, 74, 97 and 120 are preferred in that they are stable to polymerization and have high tinting strength, with C.I. Pigment Yellow 74 being more preferred.

As magenta colorants, may be used, for example, compounds, such as azo pigments such as mono-azo pigments and dis-azo pigments, and fused polycyclic pigments. Specific examples thereof include C.I. Pigment Red 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209 and 251, and C.I. Pigment Violet 19. Mono-azo pigments such as C.I. Pigment Red 31, 48, 57:1, 58, 60, 63, 64, 68, 112, 114, 146, 150, 163, 170, 185, 187, 206 and 207 are preferred in that they are stable to polymerization and have high tinting strength.

The amount of the colorant added is preferably 1 to 10 parts by weight per 100 parts by weight of the monovinyl monomer.

As the charge control agent, may be used various kinds of charge control agents having positively charging ability or negatively charging ability. The charge control agents are classified into charge control agents other than resins and charge control resins. As the charge control agents, may be used, for example, charge control agents such as metal complexes of organic compounds having a carboxyl group or a nitrogen-containing group, metallized dyes and nigrosine; and charge control resins such as quaternary ammonium (salt) group-containing copolymers, and sulfonic (salt) group-containing copolymers and carboxylic (salt) group-containing copolymers. The charge control agent preferably contains a charge control resin because the printing durability of the resulting toner is improved. As the charge control agent, the charge control resin may be used in combination with any other charge control agent than a resin, and the charge control resin may also be used singly. It is more preferable to use the charge control resin singly. It is still more preferable to use the quaternary ammonium (salt) group-containing copolymer or sulfonic (salt) group-containing copolymer as the charge control resin.

The charge control agent is used in a proportion of generally 0.01 to 10 parts by weight, preferably 0.03 to 8 parts by weight per 100 parts by weight of the monovinyl monomer.

It is preferable to use a molecular weight modifier as another additive component. Examples of the molecular weight modifier include mercaptans such as t-dodecyl-mercaptan, n-dodecylmercaptan, n-octylmercaptan and 2,2,4,6,6-pentamethylheptane-4-thiol. The molecular weight modifier may be added prior to the initiation of the polymerization or in the course of the polymerization. The amount of the molecular weight modifier used is preferably 0.01 to 10 parts by weight, more preferably 0.1 to 5 parts by weight per 100 parts by weight of the monovinyl monomer.

As another additive component, a parting agent is preferably added for improving the parting property of the resulting toner from a fixing roll upon fixing.

No particular limitation is imposed on the parting agent so far as it is that used as a parting agent for toner. Examples of the parting agent include low-molecular weight polyolefin waxes such as low-molecular weight polyethylene, low-molecular weight polypropylene and low-molecular weight polybutylene; terminal-modified polyolefin waxes such as molecular terminal-oxidized low-molecular weight polypropylene, terminal-modified low-molecular weight polypropylene with its molecular terminal substituted by an epoxy group, block polymers of these compounds with low-molecular weight polyethylene, molecular terminal-oxidized low-molecular weight polyethylene, low-molecular weight polyethylene with its molecular terminal substituted by an epoxy group, and block polymers of these compounds with low-molecular weight polypropylene; vegetable natural waxes such as candelilla wax, carnauba wax, rice wax, Japan wax and jojoba wax; petroleum waxes such as paraffin wax, microcrystalline wax and petrolatum, and modified waxes thereof; mineral waxes such as montan, ceresin and ozokerite; synthetic waxes such as Fischer-Tropsch wax; and polyhydric alcohol esters, such as pentaerythritol esters such as pentaerythritol tetramyristate, pentaerythritol tetrapalmitate, pentaerythritol tetrastearate and pentaerythritol tetralaurate, and dipentaerythritol esters such as dipentaerythritol hexamyristate, dipentaerythritol hexapalmitate and dipentaerythritol hexalaurate. These parting agents may be used either singly or in any combination thereof.

Among these parting agents, the polyhydric alcohol esters, such as pentaerythritol esters, whose endothermic peak temperatures fall within a range of generally 30 to 150° C., preferably 50 to 120° C., more preferably 60 to 100° C. as determined from a DSC curve upon heating thereof by a differential scanning calorimeter (DSC), and dipentaerythritol esters, whose endothermic peak temperatures fall within a range of 50 to 80° C. as determined likewise, are particularly preferred from the viewpoint of a balance between the fixing ability and the parting property of the resulting toner.

The amount of the parting agent used is preferably 0.1 to 30 parts by weight, more preferably 1 to 20 parts by weight per 100 parts by weight of the monovinyl monomer.

3. Droplet Forming Step:

The polymerizable monomer composition is dispersed in an aqueous medium containing a dispersion stabilizer and stirred to form uniform droplets of the polymerizable monomer composition. In the formation of the droplets of the polymerizable monomer composition, primary droplets having a volume average droplet diameter of about 50 to 1,000 μm are first formed. In order to avoid premature polymerization, it is preferable to add a polymerization initiator to the aqueous dispersion medium after the size of the droplets in the aqueous medium becomes uniform.

The polymerization initiator is added and mixed into the suspension with the primary droplets of the polymerizable monomer composition dispersed in the aqueous dispersion medium, and the resultant mixture is stirred by means of a high-speed shearing type agitator until the droplet diameter of the droplets becomes a small diameter near to the intended particle diameter of the colored polymer particles. In such a manner, fine secondary droplets having a small volume average droplet diameter of generally about 3 to 15 μm are formed.

No particular limitation is imposed on the method for forming the droplets. However, the formation is conducted by means of, for example, a device capable of strongly stirring, such as an (in-line type) emulsifying and dispersing machine (manufactured by Ebara Corporation, trade name “Milder”) or a high-speed emulsifying and dispersing machine (manufactured by Tokushu Kika Kogyo Co., Ltd., trade name “T.K. Homomixer MARK II Type”).

In the present invention, the aqueous medium may be water alone. However, a solvent soluble in water may also be used in combination with water. Examples of the solvent soluble in water include lower alcohols, dimethylformamide, tetrahydrofuran and lower ketones.

In the present invention, a dispersion stabilizer is contained in the aqueous medium. Examples of the dispersion stabilizer used in the present invention include inorganic compounds, such as sulfates such as barium sulfate and calcium sulfate; carbonates such as barium carbonate, calcium carbonate and magnesium carbonate; phosphates such as calcium phosphate; metal oxides such as aluminum oxide and titanium oxide; and metal hydroxides such as aluminum hydroxide, magnesium hydroxide and ferric hydroxide. These inorganic compounds are soluble in an acid or alkali.

Besides, an organic polymeric compound, such as a water-soluble polymer such as polyvinyl alcohol, methyl cellulose or gelatin, an anionic surfactant, a nonionic surfactant, or an amphoteric surfactant may also be used in combination.

The dispersion stabilizers may be used either singly or in any combination thereof.

Among the dispersion stabilizers, dispersion stabilizers containing colloid of a metallic compound, particularly, a hardly water-soluble metal hydroxide, are preferred because the particle diameter distribution of the resulting colored polymer particles can be narrowed, and the amount of the dispersion stabilizer remaining after washing can be lessened. In other words, when the colloid of the hardly water-soluble metal hydroxide is used as the dispersion stabilizer, the resulting polymerized toner can brightly or sharply reproduce images, and environmental safety is not deteriorated.

Examples of the polymerization initiator used for conducting the polymerization of the polymerizable monomer composition in the present invention include persulfates such as potassium persulfate and ammonium persulfate; azo compounds such as 4,4′-azobis(4-cyanovaleric acid), 2,2′-azobis(2-methyl-N-(2-hydroxyethyl)propionamide), 2,2′-azobis(2-amidinopropane)dihydrochloride, 2,2′-azobis(2,4-dimethylvaleronitrile) and 2,2′-azobisisobutyronitrile; and peroxides such di-t-butyl peroxide, benzoyl peroxide, t-butyl peroxy-2-ethylhexanoate, t-hexyl peroxy-2-ethyl hexanoate, t-butyl peroxypivalate, diisopropyl peroxydicarbonate, di-t-butyl peroxyisophthalate and t-butyl peroxyisobutyrate. Redox initiators obtained by combining these polymerization initiators with a reducing agent may also be used. Among these, the peroxides are preferably used because the amount of a residual unreacted polymerizable monomer can be lessened, and the durability of the resulting polymerized toner can be improved.

As described above, the polymerization initiator is preferably added in the course of the droplet forming step after the polymerizable monomer composition is dispersed in the aqueous medium. However, it may also be added to the polymerizable monomer composition.

The amount of the polymerization initiator added is preferably 0.1 to 20 parts by weight, more preferably 0.3 to 15 parts by weight, most preferably 1.0 to 10 parts by weight per 100 parts by weight of the monovinyl monomer.

4. Colored Polymer Particle-Forming Step:

The aqueous medium containing the droplets of the polymerizable monomer composition obtained in the above-described droplet forming step is heated to initiate polymerization.

The polymerization temperature of the polymerizable monomer composition is preferably at least 50° C., more preferably 60 to 95° C. The polymerization reaction is conducted for preferably 1 to 20 hours, more preferably 2 to 15 hours.

The colored polymer particles may be provided as colored polymer particles having a substantially homogeneous composition. However, it is preferable to provide core-shell type (also referred to as “capsule type”) colored polymer particles by using the above-described colored polymer particles as core particles and forming a shell layer different from the composition of the core particles on the surfaces of the colored polymer particles. The core-shell type colored polymer particles are formed by covering the core particles composed of a material having a low softening point with a material having a softening point higher than the core particles, whereby a balance between low-temperature fixing ability (lowering of a fixing temperature) and storage stability (prevention of aggregation upon storage) can be taken.

No particular limitation is imposed on the process for producing the core-shell type colored polymer particles, and they can be produced in accordance with a process known per se in the art. However, in-situ polymerization process and phase separation process are preferred from the viewpoint of production efficiency.

The production process of the core-shell type colored resin particles by the in-situ polymerization process will hereinafter be described.

A polymerizable monomer for shell for forming shell layers and a polymerization initiator are added into the aqueous medium, in which the colored polymer particles (core particles) formed have been dispersed, and the polymerizable monomer for shell is polymerized to form polymer layers (shell layers) for covering the core particles, whereby core-shell type colored polymer particles can be obtained.

As the polymerizable monomer for shell, may be used the same monomers as the polymerizable monomers mentioned above. Among these, polymerizable monomers respectively forming polymers having a Tg exceeding 80° C., such as styrene, acrylonitrile and methyl methacrylate, are preferably used either singly or in combination of two or more monomers thereof.

As examples of polymerization initiators used in the polymerization of the polymerizable monomer for shell, may be mentioned water-soluble polymerization initiators, such as persulfates such as potassium persulfate and ammonium persulfate; and azo type initiators such as 2,2′-azobis(2-methyl-N-(2-hydroxyethyl)propionamide) and 2,2′-azobis-(2-methyl-N-(1,1-bis(hydroxymethyl)-2-hydroxyethyl)-propionamide). The amount of the polymerization initiator added is preferably 0.1 to 30 parts by weight, more preferably 1 to 20 parts by weight per 100 parts by weight of the polymerizable monomer for shell.

The polymerization temperature of the polymerizable monomer for shell is preferably at least 50° C., more preferably 60 to 95° C. The polymerization reaction is conducted for preferably 1 to 20 hours, more preferably 2 to 15 hours.

5. Washing Step:

The colored polymer particles formed by the polymerization are washed in the washing step. The washing step according to the present invention comprises an acid-washing or alkali-washing step, a water-washing step and a centrifugal separation step.

5-1. Acid-Washing or Alkali-Washing Step:

The aqueous dispersion containing the colored polymer particles formed by the polymerization contains the dispersion stabilizer. A great number of fine particles of the dispersion stabilizer adhere to the surfaces of the colored polymer particles. When an inorganic compound soluble in an acid, such as an inorganic hydroxide, is used as the dispersion stabilizer, the acid is added into the aqueous dispersion containing the colored polymer particles formed to dissolve the dispersion stabilizer in water, thereby removing the dispersion stabilizer. When the dispersion stabilizer is an inorganic compound soluble in an alkali, the alkali is added into the aqueous dispersion containing the colored polymer particles to dissolve the dispersion stabilizer in water, thereby removing the dispersion stabilizer.

For example, when colloid of a hardly water-soluble metal hydroxide, such as colloid of magnesium hydroxide, is used as the dispersion stabilizer, an acid such as sulfuric acid is added to the aqueous dispersion to solubilize the dispersion stabilizer in water (this process being referred to as “acid washing”). The pH of the aqueous dispersion is adjusted to generally 6.5 or lower, preferably 2 to 6.5, more preferably 3 to 6.0 by the acid washing. As the acid added, may be used an inorganic acid such as sulfuric acid, hydrochloric acid or nitric acid, or an organic acid such as formic acid or acetic acid. However, sulfuric acid is particularly preferred because of high removing efficiency and small burden on production equipment.

5-2. Water-Washing Step:

The aqueous dispersion obtained in the acid-washing or alkali-washing step is filtered to separate the colored polymer particles. The colored polymer particles separated by filtration are then washed with water, and the washing water is filtered. In the water-washing step, the colored polymer particles are washed with water until the electric conductivity of a filtrate (washing water used in the filtration) is lowered to at most 1,000 μS/cm, and the washing water is filtered. This water-washing step may be conducted repeatedly by a batch system or continuously by means of a belt filter or the like.

The electric conductivity of the filtrate is preferably at most 500 μS/cm, more preferably at most 200 μS/cm, particularly preferably at most 90 μS/cm, most preferably at most 60 μS/cm. It is considered that when the water washing is conducted until the electric conductivity of the filtrate falls within the above range, the adhesion of the secondarily produced fine particles to the colored polymer particles is weakened. As a result, it is easy to remove the secondarily produced fine particles from the colored polymer particles in the centrifugal separation step subsequent to the water-washing step.

The electric conductivity of water used in the water washing is preferably at most 100 μS/cm, more preferably at most 50 μS/cm, particularly preferably at most 20 μS/cm.

As washing devices used in the water washing, may be used publicly known various washing devices. However, a belt filter, a rotary filter and a filter press are preferably used either singly or in any combination thereof. Among these washing devices, the belt filter and the rotary filter are preferred.

The belt filter generally has a structure that a filter medium is arranged on a drainage belt, and a vacuum pan is provided under the drainage belt through a slide plate excellent in abrasion resistance. The aqueous dispersion is fed on to the filter medium from above a filtering surface and filtered and dehydrated by a vacuum action. A filtrate is collected in the vacuum pan and sent to a vacuum tank through a filtrate tube. A cake (wet cake of the colored polymer particles in a wetted state) obtained by the filtration and the filter medium travel together with the drainage belt, and meanwhile washing water is sprayed on the cake from above, whereby soluble substances in the cake are discharged together with the filtrate. The dehydrated cake is separated from the filter medium by a discharge roll.

The rotary filter is a horizontal filter also called a continuous pressure filter. As a specific continuous pressure filter, is mentioned a trade name “Rotary Filter RF-2” (manufactured by KOTOBUKI INDUSTRIES CO., LTD.).

5-3. Centrifugal Separation Step:

In the present invention, water is added to the colored polymer particles in the wetted state obtained in the above-described water-washing step to prepare an aqueous dispersion containing the colored polymer particles again. The solid content concentration of the aqueous dispersion is generally 5 to 50% by weight, preferably 10 to 35% by weight.

The aqueous dispersion thus obtained is subjected to centrifugal separation by means of a decanter type centrifugal separator, which has an outside rotary cylinder and a screw conveyor relatively rotatably provided within the outside rotary cylinder, thereby removing the secondarily produced fine particles to reduce the number of the secondarily produced fine particles to at most forty on the average.

The number of the secondarily produced fine particles in the present invention means a number obtained by calculating out the number of secondarily produced fine particles per one of the colored polymer particles from an image by an electron microscope and averaging the values thus obtained. More specifically, with respect to each sample of the colored polymer particles, images are photographed in 5 fields of view by the electron microscope, and 10 colored polymer particles are selected at random from each image. The number of secondarily produced fine particles observed on the surfaces of these 50 colored polymer particles in total is counted to calculate out the number of the secondarily produced fine particles per one of the colored polymer particles by arithmetic mean.

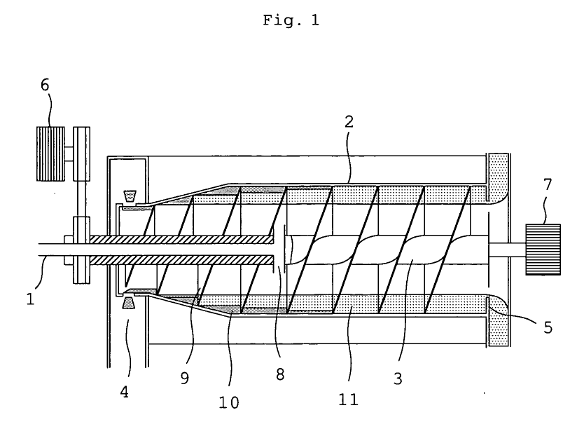

The centrifugal separator used in the centrifugal separation step according to the present invention is a decanter type centrifugal separator, which has an outside rotary cylinder and a screw conveyor relatively rotatably provided within the outside rotary cylinder. The structure of the decanter type centrifugal separator is illustrated in FIG. 1.

The decanter type centrifugal separator used in the present invention is a horizontal centrifugal separator. This decanter type centrifugal separator has an outside rotary cylinder 2 and a screw conveyor 3 relatively rotatably provided within the outside rotary cylinder 2. A feed tube 1 is provided within the screw conveyor 3. The feed tube 1 is linked to a feeding opening 8 in the interior of the device, and the aqueous dispersion containing solids is fed into the outside rotary cylinder 2 from the feeding opening 8 through the feed tube 1. The outside rotary cylinder 2 is rotated at a high speed to give the aqueous dispersion centrifugal force, thereby sedimenting the solids on the inner wall of the outside rotary cylinder 2.

The sedimented solids 10 are scraped up by blades 9 of the screw conveyor 3 rotating coaxially with the outside rotary cylinder 2 in the same direction with a little rotational speed difference and caused to successively travel in one direction to be discharged from a solid discharge opening 4. A liquid (separated liquid) 11 separated from the solids is caused to travel in the other direction to be overflowed and discharged through a dam plate 5 for controlling a liquid level. The outside rotary cylinder 2 and screw conveyor 3 are driven by a drive motor 6 and supported by a gear box 7.

More specifically, in the centrifugal separation step 2c,

the aqueous dispersion containing the colored polymer particles is fed into the outside rotary cylinder 2 of the decanter type centrifugal separator, which has the outside rotary cylinder 2 and the screw conveyor 3 relatively rotatably provided within the outside rotary cylinder 2, from the feeding opening 8 arranged in the interior of the device through the feed tube 1 provided within the screw conveyor 3,

the outside rotary cylinder 2 is rotated at a high speed to give the aqueous dispersion centrifugal force, thereby sedimenting the colored polymer particles on the inner wall of the outside rotary cylinder 2,

the sedimented colored polymer particles 10 are scraped up by the blades 9 of the screw conveyor 3 rotating coaxially with the outside rotary cylinder 2 in the same direction with a little rotational speed difference and caused to successively travel in one direction to be discharged from the solid discharge opening 4, and

a liquid 11 separated from the colored polymer particles is overflowed and discharged through the dam plate 5 for controlling a liquid level. At this time, the secondarily produced fine particles are also discharged together with the liquid.

The amount L (liter/hr) of the colored polymer particle-containing aqueous dispersion fed into the decanter type centrifugal separator is preferably 8.0 to 32.5, more preferably 16.2 to 24.3 in terms of a ratio L/V of the amount L to the volume V (liter) of the outside rotary cylinder. When a decanter type centrifugal separator, whose outside rotary cylinder has a diameter of 150 mm and a length of 350 mm, is used, L is preferably 50 to 200 liters/hr, more preferably 100 to 150 liters/hr. If the amount of the aqueous dispersion fed is too small, productivity is extremely lowered though separation efficiency is enhanced. If the amount of the aqueous dispersion fed is too great, the residence time of the aqueous dispersion in the decanter type centrifugal separator is extremely lowered to lower the separation efficiency, so that the secondarily produced fine particles cannot be sufficiently removed, and moreover leakage of the colored polymer particles into the liquid separated from the colored polymer particles becomes marked to incur lowering of yield.

A relative difference in rotational speed between the outside rotary cylinder and the screw conveyor may be suitably set. However, the difference is preferably 5 to 30 revolutions per minute. If the difference in rotational speed is less than 5 revolutions, an amount of the colored polymer particles discharged to an amount of the colored polymer particles fed becomes smaller, and many of the colored polymer particles are leaked into the separated liquid to incur lowering of yield. If the difference in rotational speed exceeds 30 revolutions on the other hand, the residence time of the aqueous dispersion in the outside rotary cylinder is insufficient, so that the separation of the secondarily produced fine polymer particles becomes insufficient.

The dam plate for controlling the liquid level of the separated liquid may be suitably adjusted according to the filterability of a material to be treated.

The centrifugal effect G brought about by the high-speed rotation of the outside rotary cylinder may be optionally set by controlling the rotational speed. In the present invention, the centrifugal effect G is preferably 1,000 to 5,000 G, more preferably 1,500 to 4,000 G. These ranges of the centrifugal effect G correspond to 3,452 to 7,720 rpm and 4,228 to 6,905 rpm, respectively, when a decanter type centrifugal separator, whose outside rotary cylinder has a radius of 7.50 cm, is used.

If the centrifugal effect G is too small, the separability of the colored polymer particles from the secondarily produced fine particles becomes poor, and so the amount of the secondarily produced fine particles adhere to the colored polymer particles increases. If the centrifugal effect G is too great, the separability is improved, whereas mechanical impact force against the resultant colored polymer particles becomes too strong, so that the colored polymer particles are cracked or crushed. The centrifugal effect G falling within the above range is very preferred because the damage to the colored polymer particles can be inhibited while retaining the good separability.

6. Collecting Step (Dehydration and Drying)

After the washing step, the colored polymer particles in the wetted state are dehydrated in a dehydration step and then dried. It is preferable from the viewpoint of treatment operation to add water to the colored polymer particles in the wetted state prior to the dehydration to prepare an aqueous dispersion having a solid content concentration of 5 to 50% by weight, preferably 10 to 30% by weight.

No particular limitation is imposed on a dehydration method. As examples of the dehydration method, may be mentioned centrifugal filtration, vacuum filtration and pressure filtration methods. Among these, the centrifugal filtration method is preferred. As examples of a filter and dehydrater, may be mentioned a peeler centrifuge and a siphon peeler centrifuge.

In the centrifugal filtration method, centrifugal gravity is set to generally 400 to 3,000 G, preferably 800 to 2,000 G. The water content in the colored polymer particles after the dehydration is generally 5 to 30% by weight, preferably 8 to 25% by weight. If the water content is too high, it takes a long time for the subsequent drying step. In addition, even when the concentration of an ionic component in water is low, the impurities are concentrated by drying if the water content is high, so that the dependence of the resulting polymerized toner (developer) on environment becomes high.

No particular limitation is imposed on a drying method, and various methods such as vacuum drying, flash drying and use of a spray dryer may be used.

7. Colored Polymer Particles:

The volume average particle diameter Dv of the colored polymer particles (including core-shell type colored polymer particles) making up the polymerized toner according to the present invention is preferably 3 to 15 μm, more preferably 4 to 12 μm. If the Dv of the colored polymer particles is too small, the flowability of the resulting polymerized toner is lowered, so that such a polymerized toner shows a tendency to lower transferability, cause blurring or lower a printing density. If the Dv of the colored polymer particles is too great, the resulting polymerized toner shows a tendency to deteriorate the resolution of an image formed with such a toner.

A ratio Dv/Dp (particle diameter distribution) of the volume average particle diameter Dv of the colored polymer particles to the number average particle diameter Dp thereof is preferably 1.0 to 1.3, more preferably 1.0 to 1.2. If the Dv/Dp is too high, the resulting polymerized toner shows a tendency to cause blurring or lower transferability, printing density and resolution when the polymerized toner is used in printing. The volume average particle diameter and number average particle diameter of the colored polymer particles can be measured by means of a Multisizer (manufactured by Beckmann Coulter Co.).

The spheroidicity Sc/Sr of the colored polymer particles according to the present invention is preferably 1.0 to 1.3, more preferably 1.0 to 1.2. If the spheroidicity Sc/Sr is too high, the resulting polymerized toner shows a tendency to lower its transferability and flowability or easily cause blurring when the polymerized toner is used in printing.

The spheroidicity Sc/Sr of the colored polymer particles is determined in the following manner. The colored polymer particles are photographed by an electron microscope, and the resultant photograph is processed by means of an image processing analyzer (manufactured by NIRECO Corporation, trade name “LUZEX IID”) under conditions of an area rate of particles to a frame area of 2% in maximum and a total processing number of 100 particles. The thus-obtained spheroidicity Sc/Sr values of the 100 colored polymer particles are averaged to find an average spheroidicity.
Spheroidicity=Sc/Sr
wherein Sc: an area of a circle supposing that the absolute maximum length of a colored polymer particle is a diameter, and
Sr: a substantial projected area of the colored polymer particle.
   8. Polymerized Toner:

In the present invention, the colored polymer particles may also be used as a polymerized toner in development of electrophotographs as it is. In order to control the charging properties, flowability and storage stability and the like, the colored polymer particles may be mixed with an external additive and optional other particles, thereby providing a one-component developer (one-component polymerized toner). In addition to the colored polymer particles, external additive and optional other particles, carrier particles such as ferrite or iron powder may also be mixed in accordance with any of publicly known various methods to provide a two-component developer (two-component polymerized toner).

As the external additive, may be mentioned inorganic particles and organic resin particles generally used for the purpose of improving flowability and charging properties. Examples of the inorganic particles include particles of silica, aluminum oxide, titanium oxide, zinc oxide, tin oxide, calcium carbonate, calcium phosphate and cesium oxide. Examples of the organic resin particles include particles of methacrylic ester polymers, acrylic ester polymers, styrene-methacrylic ester copolymers, styrene-acrylic ester copolymers and melamine resins, and core-shell type particles in which the core is composed of a styrene polymer, and the shell is composed of a methacrylic ester polymer. Among these, the particles of silica and titanium oxide are preferred, and particles obtained by subjecting these surfaces to a hydrophobicity-imparting treatment are more preferred, with silica particles subjected to a hydrophobicity-imparting treatment being particularly preferred. It is more preferable to use two or more kinds of silica particles subjected to the hydrophobicity-imparting treatment in combination.

No particular limitation is imposed on the amount of the external additive added. However, it is generally 0.1 to 6 parts by weight per 100 parts by weight of the colored polymer particles.

### EXAMPLES

The production process according to the present invention will hereinafter be described more specifically by the following examples. However, the present invention is not limited to the following examples only. Incidentally, all designations of “part” or “parts” and “%” as will be used in the following examples mean part or parts by weight and % by weight unless expressly noted.

Testing methods performed in EXAMPLES are as follows.

(1) Electric Conductivity of Filtrate:

An aqueous dispersion of colored polymer particles during a water-washing step was sampled, and a filtrate obtained by dehydration thereof was subjected to measurement by means of a conductometer (manufactured by Horiba Ltd., trade name “ES-12”) under conditions of 25° C.±0.5° C.

(2) Number of Secondarily Produced Fine Particles:

A field emission type scanning electron microscope (manufactured by Hitachi Ltd., trade name “S-4700”) was used to observe surfaces of colored polymer particles at 5,000 magnifications.

With respect to each sample, images were photographed in 5 fields of view, and 10 colored polymer particles were selected at random from each image. The number of secondarily produced fine particles observed on the surfaces of these 50 colored polymer particles in total was counted, thereby calculating out the number of the secondarily produced fine particles per one of the colored polymer particles. The secondarily produced fine particles can be easily distinguished because they have a markedly small diameter (nanomicron order) compared with the colored polymer particles (polymerized toner).

(3) Printing Test (Number of Paper Sheets Printed up to Occurrence of Filming):

A commercially available printer (18 papers per minute printer; printing speed: 18 paper sheets per minute) of a non-magnetic one-component development system was used. After a polymerized toner to be tested was charged into a developing device of this printer and left to stand for a day under an environment of 23° C. in temperature and 50% in humidity, continuous printing was conducted on 5,000 sheets of paper at a printing density of 1%. A solid image was printed every 1,000 sheets of paper to confirm whether vertical stripes occurred or not. The number of paper sheets printed until the vertical stripes were observed for the first time was regarded as the number of paper sheets printed up to occurrence of filming. In Table 1, the fact that the number of paper sheets printed up to occurrence of filming is >5,000 indicates that no filming occurred at the time printing was conducted on 5,000 sheets of paper.

### Example 1

In a media type dispersing machine (manufactured by TURBO KOGYO CO., LTD., trade name “OB Beads Mill”), 88 parts of styrene and 12 parts of n-butyl acrylate as monovinyl monomers, and 7 parts of C.I. Pigment Yellow 74 (product of Sanyo Color Works, Ltd., trade name “Fast Yellow 7415”) were subjected to a dispersing treatment to obtain a polymerizable monomer dispersion.

With the thus-obtained polymerizable monomer dispersion were mixed 4 parts of a positive charge control resin (quaternary ammonium salt group-containing styrene/acrylic resin; monomer composition of a monomer having a quaternary ammonium salt group=2% by weight; product of Fujikura Kasei Co., Ltd., trade name “FCA-207P”), 8 parts of dipentaerythritol hexamyristate (parting agent; maximum endothermic peak temperature by DSC: 66.2° C., molecular weight: 1,514) and 0.25 part of a polymethacrylic ester macromonomer (product of Toagosei Chemical Industry Co., Ltd., trade name “AA6”, Tg: 94° C.) to prepare a polymerizable monomer composition.

On the other hand, an aqueous solution with 5 parts of sodium hydroxide (alkali metal hydroxide) dissolved in 50 parts of ion-exchanged water was gradually added to an aqueous solution with 6.5 parts of magnesium chloride (water-soluble polyvalent metal salt) dissolved in 250 parts of ion-exchanged water under stirring to prepare an aqueous dispersion medium containing magnesium hydroxide colloid (colloid of hardly water-soluble metal hydroxide).

After the polymerizable monomer composition was poured into the aqueous dispersion medium containing the magnesium hydroxide colloid obtained above, and the resultant mixture was stirred until primary droplets became stable, 0.7 part of divinylbenzene as a crosslinking agent, 1.0 part of tert-dodecanethiol as a molecular weight modifier and 5 parts of t-butyl peroxy-2-ethylhexanoate (product of Nippon Oil & Fats Co., Ltd., trade name “Perbutyl O”) as a polymerization initiator were added. This mixture was stirred under high shearing by means of an in-line type dispersing machine (manufactured by Ebara Corporation, trade name “Ebara Milder”) to form droplets (secondary droplets) of the polymerizable monomer composition.

A reactor equipped with an agitating blade was charged with the aqueous dispersion medium obtained by the formation of the droplets, and the contents were heated to 90° C. to conduct a polymerization reaction. After a conversion into a polymer reached almost 100%, 1 part of methyl methacrylate as a polymerizable monomer for shell was added to the reactor, and an aqueous solution with 0.1 part of 2,2′-azobis(2-methyl-N-(2-hydroxyethyl)-propionamide) (product of Wako Pure Chemical Industries, Ltd., trade name “VA086”) dissolved in 10 parts of ion-exchanged water was further added after 10 minutes. After the polymerization was continued for 3 hours, the reaction mixture was cooled to stop the reaction, thereby obtaining an aqueous dispersion containing colored polymer particles formed.

The pH of the aqueous dispersion of the colored polymer particles obtained in the above-described manner was 9.5. As a washing step, sulfuric acid was first added to 600 kg of this aqueous dispersion of the colored polymer particles until the pH was turned to 6.0 to conduct acid washing.

The aqueous dispersion of the colored polymer particles obtained by the acid washing was then subjected to a water-washing step under the following conditions by means of a continuous belt filter (manufactured by Sumitomo Heavy Industries, Ltd., trade name “Eagle Filter”).
Filtering area: 1 m²
Feed rate of aqueous dispersion of colored polymer particles: 200 kg/hr
Belt speed: 0.6 m/min
Electric conductivity of washing water: 2 μS/cm
Feed rate of washing water: 600 kg/hr
Degree of vacuum: 53,000 to 67,000 Pa.

After completion of water washing by this belt filter, the number of secondarily produced fine particles adhered to the colored polymer particles was counted and found to be 100 particles.

From the colored polymer particles in the wetted state obtained by this water washing, an aqueous dispersion was prepared again by adding ion-exchanged water so as to give a solid content concentration of 20% by weight. A part of the thus-obtained aqueous dispersion was sampled and filtered. As a result, the electric conductivity of a filtrate was 32 μS/cm.

As a washing step, the aqueous dispersion prepared again was finally subjected to a centrifugal separation step under the following conditions by means of a decanter type centrifugal separator (manufactured by Tomoe Engineering Co., Ltd., trade name “TOMO-E DECANTER” PTM006 MODEL).
Centrifugal effect: 2,100 G (5,003 rpm)
Difference in rotational speed between the outside rotary cylinder and the screw conveyor: 20 rpm
Feed rate of aqueous dispersion: 100 liters/hr.

The water content in the colored polymer particles discharged after the centrifugal separation step was 43% by weight, and the number of the secondarily produced fine particles was reduced to 3.5 particles. Ion-exchanged water was added to the colored polymer particles again so as to give a solid content concentration of 20% by weight to prepare 600 kg of an aqueous dispersion again. Thereafter, the aqueous dispersion was dehydrated as a dehydration step under the following conditions by means of a siphon peeler type centrifuge (manufactured by Mitsubishi Kakoki Kaisha Ltd., trade name “HZ-Si HZ40-Si Model”). It took 100 batches to dehydrate all of 600 kg of the aqueous dispersion.

Filtering area: 0.25 m²

Feed rate of aqueous dispersion per batch: 6 kg/batch

Centrifugal effect: 2,000 G.

The water content in the colored polymer particles after this dehydration step was 15% by weight. The particle diameter of the colored polymer particles was such that Dv50 (50% cumulative value of volume particle diameter distribution) was 9.8 μm and Dp50 (50% cumulative value of number particle diameter distribution) was 8.1 μm.

The colored polymer particles obtained in the dehydration step were dried to obtain colored polymer particles in the dried state. Into 100 parts of the dried colored polymer particles were added 0.5 part of finely particulate silica (product of Nippon Aerosil Co., Ltd., trade name “REA200”) subjected to a hydrophobicity-imparting treatment and 1.0 part of finely particulate silica (product of Nippon Aerosil Co., Ltd., trade name “NA-50Y”) subjected to a hydrophobicity-imparting treatment, and they were mixed by means of a Henschel mixer to prepare a polymerized toner with silica attached to the surface thereof.

The thus-obtained polymerized toner was subjected to the printing test by means of the commercially available printer of a non-magnetic one-component development system. The results of the test are shown in Table 1.

### Example 2

A polymerized toner was prepared in the same manner as in Example 1 except that the centrifugal effect of the decanter type centrifugal separator in Example 1 was changed to 3,100 G (6,078 rpm).

The thus-obtained polymerized toner was subjected to the printing test by means of the commercially available printer of a non-magnetic one-component development system. The results of the test are shown in Table 1.

### Comparative Example 1

A polymerized toner was prepared in the same manner as in Example 1 except that the water-washing step by the belt filter in Example 1 was not conducted.

The electric conductivity of a filtrate after the aqueous dispersion prior to the centrifugal separation step was filtered was 50,900 μS/cm. The number of the secondarily produced fine particles after the centrifugal separation step was 100 particles. The water content in the colored polymer particles in the wetted state after the dehydration step was 17% by weight.

After the drying, the printing test was performed under the same conditions as in Example 1. As a result, white stripes occurred on a print at the time continuous printing was conducted on 30 sheets of paper. A toner cartridge was disassembled to observe it. As a result, white filming was observed on a developing blade. The results of the test are shown in Table 1.

### Comparative Example 2

A polymerized toner was prepared in the same manner as in Example 1 up to before the centrifugal separation step. However, the centrifugal separation step was not conducted. Thereafter, a dehydration step by the siphon peeler type centrifuge was conducted in the same manner as in Example 1. However, a failure in dehydration due to clogging of the filter medium by secondarily produced fine particles occurred in the dehydration of the twelfth batch, and dehydration after this was impossible. The water content in the colored polymer particles at this point of time was 32% by weight, and the number of the secondarily produced fine particles was 300 particles. Thereafter, the filter medium was exchanged to resume the dehydration step. However, a failure in dehydration occurred again in the dehydration of the twelfth batch. After the dehydration was stopped at this point of time, and the colored polymer particles were dried, the printing test was performed in the same manner as in Example 1. As a result, white stripes occurred on a print at the time continuous printing was conducted on 50 sheets of paper. Accordingly, the printing test was stopped at this point of time. A toner cartridge after the test was disassembled to observe it. As a result, white filming was observed on a developing blade.

### Comparative Example 3

A polymerized toner was prepared in the same manner as in Example 1 up to before the centrifugal separation step. Thereafter, a water-washing step by the belt filter was conducted again in place of the centrifugal separation step in Example 1. The number of the secondarily produced fine particles after the second water-washing step was 70 particles. After this, an aqueous dispersion was prepared again in the same manner as in Example 1, and the dehydration step was then started. However, a failure in dehydration occurred like Comparative Example 2 in the dehydration of the twenty-seventh batch. The water content in the colored polymer particles at this point of time was 30% by weight, and the number of the secondarily produced fine particles was 300 particles.

The filter medium was exchanged to resume the dehydration. However, a failure in dehydration occurred again in the dehydration of the twenty-seventh batch. After the colored polymer particles obtained were dried, the printing test was performed in the same manner as in Example 1. As a result, white stripes occurred on a print at the time continuous printing was conducted on 80 sheets of paper. Accordingly, the printing test was stopped at this point of time. A toner cartridge after the test was disassembled to observe it. As a result, white filming was observed on a developing blade.

TABLE 1

| | Ex. 1 | Ex. 2 | Comp. Ex. 1 | Comp. Ex. 2 | Comp. Ex. 3 |
|---|---|---|---|---|---|
| Electric conductivity of filtrate | 32 | 35 | 50.900 (*) | 38 | 30 |
| after water-washing step (μS/cm) | | | | | |
| Electric conductivity of filtrate | 15 | 13 | 4,800 | — | 5 |
| after centrifugal separation step | | | | | |
| (μS/cm) | | | | | |
| Number of secondarily produced fine | 3.5 | 1.5 | 100 | 100 | 70 |
| particles (particles) | | | | | |
| Occurrence of failure in | Not | Not | Not | Occurred at | Occurred at |
| dehydration in dehydration step | occurred | occurred | occurred | 12^{th} batch | 27^{th} batch |
| Image evaluation | | | | | |
| Number of paper sheets printed up | >5,000 | >5,000 | 30 | 50 | 80 |
| to occurrence of filming | | | | | |

*Aqueous dispersion after the acid-washing step.

From the test results shown in Table 1, the following facts are known.

The polymerized toner of Comparative Example 1, in which no water-washing step was conducted, were great in the number of the secondarily produced fine particles, and the filming occurred on the thirtieth printed paper sheet. In Comparative Example 2, in which no centrifugal separation step was conducted, and Comparative Example 3, in which the water washing by the belt filter was conducted again in place of the centrifugal separation step, a failure in dehydration occurred in the dehydration step.

On the other hand, in Examples, in which the washing was conducted in accordance with the production process according to the present invention, no failure in dehydration occurred, almost all the secondarily produced fine particles were removed from the resultant polymerized toners, and no filming occurred even at the time the continuous printing was conducted on 5,000 sheets of paper in the printing test.

### INDUSTRIAL APPLICABILITY

According to the present invention, there can be stably and efficiently produced polymerized toners which are extremely little in the number of secondarily produced fine particles produced upon polymerization and adhered to colored polymer particles formed, hard to cause a filming phenomenon even when durable printing is conducted, and excellent in durability.

The polymerized toners obtained by the present invention can be used as developers in image forming apparatus by an electrophotographic system, such as facsimiles, copying machines and printers.

What is claimed is:

1. A process for producing a polymerized toner, which comprises:
Step 1 of forming colored polymer particles, including the step of polymerizing a polymerizable monomer composition containing a polymerizable monomer and a colorant in an aqueous medium containing a dispersion stabilizer;
Step 2 of washing the colored polymer particles formed; and
Step 3 of collecting the colored polymer particles, wherein
the washing step 2 comprises:
i) an acid-washing or alkali-washing step 2a of adding an acid or alkali to an aqueous dispersion containing the colored polymer particles formed in the forming step 1 to dissolve the dispersion stabilizer;
ii) a water-washing step 2b of separating the colored polymer particles by filtration from the aqueous dispersion after the acid-washing or alkali-washing step 2a, then washing the colored polymer particles with water until the electric conductivity of a filtrate is lowered to at most 1,000 μS/cm, and filtering the washing water; and
iii) a centrifugal separation step 2c of adding water to the colored polymer particles in a wetted state obtained in the water-washing step 2b to prepare an aqueous dispersion containing the colored polymer particles again, and then feeding the aqueous dispersion to a decanter type centrifugal separator, which has an outside rotary cylinder and a screw conveyor relatively rotatably provided within the outside rotary cylinder, thereby conducting the centrifugal separation of the colored polymer particles, and wherein
the number of secondarily produced fine particles of sub-micron order, which adhere to the individual colored polymer particles obtained by the washing step 2, is at most forty on the average.

2. The production process according to claim 1, wherein in the forming step 1, the polymerizable monomer composition containing the polymerizable monomer and the colorant is polymerized in the aqueous medium containing the dispersion stabilizer to form the colored polymer particles.

3. The production process according to claim 1, wherein in the forming step 1, the polymerizable monomer composition containing the polymerizable monomer and the colorant is polymerized in the aqueous medium containing the dispersion stabilizer to form the colored polymer particles which will become core particles, and a polymerizable monomer for shell is polymerized in the presence of the core particles to form a polymer layer on the surfaces of the core particles, thereby forming core-shell type colored polymer particles.

4. The production process according to claim 1, wherein in the forming step 1, colored polymer particles having a volume average particle diameter of 3 to 15 μm are formed.

5. The production process according to claim 1, wherein in the forming step 1, an inorganic compound soluble in an acid is used as the dispersion stabilizer, and in the step 2a, the acid is added to the aqueous dispersion containing the colored polymer particles formed in the forming step 1 to dissolve the inorganic compound, thereby conducting acid washing.

6. The production process according to claim 5, wherein the acid is added to the aqueous dispersion to adjust the pH of the aqueous dispersion within a range of 2.0 to 6.5, thereby conducting the acid washing.

7. The production process according to claim 1, wherein in the water-washing step 2b, the colored polymer particles are separated by filtration from the aqueous dispersion after the acid-washing or alkali-washing step 2a using at least one washing device selected from the group consisting of a belt filter, a rotary filter and a filter press, the colored polymer particles are then washed with water until the electric conductivity of a filtrate is lowered to at most 1,000 μS/cm, and the washing water is filtered.

8. The production process according to claim 1, wherein in the water-washing step 2b, the colored polymer particles are washed with water until the electric conductivity of a filtrate is lowered to at most 60 μS/cm, and the washing water is filtered.

9. The production process according to claim 1, wherein in the water-washing step 2b, water having an electric conductivity of at most 20 μS/cm is used to conduct the washing.

10. The production process according to claim 1, wherein the decanter type centrifugal separator used in the centrifugal separation step 2c and having the outside rotary cylinder and the screw conveyor relatively rotatably provided within the outside rotary cylinder has a structure so constructed that
a feed tube is provided within the screw conveyor,
the feed tube is linked to a feeding opening in the interior of the device,
the aqueous dispersion containing solids is fed into the outside rotary cylinder from the feeding opening through the feed tube,
the outside rotary cylinder is rotated at a high speed to give the aqueous dispersion centrifugal force, thereby sedimenting the solids on the inner wall of the outside rotary cylinder,
the sedimented solids are scraped up by blades of the screw conveyor rotating coaxially with the outside rotary cylinder in the same direction with a little rotational speed difference and caused to successively travel in one direction to be discharged from a solid discharge opening, and
a liquid separated from the solids is caused to travel in the other direction to be overflowed and discharged through a dam plate for controlling a liquid level.

11. The production process according to claim 10, wherein in the centrifugal separation step 2c,
the aqueous dispersion containing the colored polymer particles formed by the polymerization of the polymerizable monomer composition is fed into the outside rotary cylinder of the decanter type centrifugal separator, which has the outside rotary cylinder and the screw conveyor relatively rotatably provided within the outside rotary cylinder, from the feeding opening arranged in the interior of the device through the feed tube provided within the screw conveyor,
the outside rotary cylinder is rotated at a high speed to give the aqueous dispersion centrifugal force, thereby sedimenting the colored polymer particles on the inner wall of the outside rotary cylinder,
the sedimented colored polymer particles are scraped up by the blades of the screw conveyor rotating coaxially with the outside rotary cylinder in the same direction with a little rotational speed difference and caused to successively travel in one direction to be discharged from the solid discharge opening, and
a liquid separated from the colored polymer particles is overflowed and discharged through the dam plate for controlling a liquid level, and at this time, the secondarily produced fine particles are also discharged together with the liquid.

12. The production process according to claim 1, wherein in the centrifugal separation step 2c, the amount L (liter/hr) of the aqueous dispersion fed into the decanter type centrifugal separator is controlled in such a manner that a ratio L/V of the amount L to the volume V (liter) of the outside rotary cylinder is 8.0 to 32.5.

13. The production process according to claim 1, wherein in the centrifugal separation step 2c, the outside rotary cylinder and the screw conveyor are relatively rotated by setting a difference in rotational speed between the outside rotary cylinder and the screw conveyor so as to be 5 to 30 revolutions per minute.

14. The production process according to claim 1, wherein in the centrifugal separation step 2c, the outside rotary cylinder in the decanter type centrifugal separator is rotated in such a manner that the centrifugal effect falls within a range of 1,000 to 5,000 G.

15. The production process according to claim 1, wherein colored polymer particles, in which the number of secondarily produced fine particles adhered to a colored polymer particle is at most twenty on the average, are obtained by the washing step 2.

16. The production process according to claim 1, wherein colored polymer particles, in which the number of secondarily produced fine particles adhered to a colored polymer particle is at most ten on the average, are obtained by the washing step 2.

17. The production process according to claim 1, wherein in the collecting step 3, water is added to the colored polymer particles in a wetted state, which have been subjected to centrifugal separation in the centrifugal separation step 2c, to prepare an aqueous dispersion, and the aqueous dispersion is then dehydrated and dried.

18. The production process according to claim 17, wherein in the collecting step 3, the aqueous dispersion prepared by adding water to the colored polymer particles in the wetted state, which have been subjected to centrifugal separation in the centrifugal separation step 2c, are dehydrated by means of a siphon peeler type centrifuge.

19. The production process according to claim 17, wherein in the collecting step 3, colored polymer particles having a water content of 5 to 30% by weight are obtained by the dehydration, and the colored polymer particles are dried.

20. The production process according to claim 1, wherein colored polymer particles, in which the volume average particle diameter Dv thereof is 3 to 15 μm, and a ratio Dv/Dp of the volume average particle diameter Dv to the number average particle diameter Dp is 1.0 to 1.3, are obtained by the collecting step 3.
